(19) United States
(12) Patent Application Publication
(10) Pub. No.: US 2022/0077625 A1
(43) Pub. Date: Mar. 10, 2022

(54) CONNECTOR HOUSING AND WIRE HARNESS

(71) Applicant: Yazaki Corporation, Tokyo (JP)

(72) Inventors: Shintaro YAGI, Kakegawa-shi (JP); Shin KONO, Kakegawa-shi (JP)

(73) Assignee: Yazaki Corporation, Tokyo (JP)

(21) Appl. No.: 17/464,844

(22) Filed: Sep. 2, 2021

(30) Foreign Application Priority Data
Sep. 8, 2020 (JP) 2020-150593

(51) Int. Cl. H01R 13/52; H01R 13/502; H01R 13/516; H01R 13/629; H01B 7/00

(52) U.S. Cl. CPC H01R 13/5205; H01R 13/502; H01B 7/0045; H01R 13/629; H01R 13/516

(57) ABSTRACT

A connector housing includes a housing main body, a seal element between an electric wire section of a terminal-equipped electric wire and the housing main body, and a rear holder configured to be attached to the housing main body so as to close the rear side opening and has a passage hole for the electric wire section and a plurality of protrusions, the passage hole having a larger opening area than a radial cross section area of the electric wire section, wherein the protrusions protrude from an inner circumferential surface of the passage hole with a protrusion length in such a way that one of vertices is positioned in each of three regions of the passage hole which are obtained by dividing it equally in a plan view on the passage hole, the protrusion length being adapted to an inner circumference position of a sealing through hole.

### BACKGROUND OF THE INVENTION

### Technical Field

The present invention relates to a connector housing configured to accommodate a connector terminal of a terminal-equipped electric wire, and a wire harness with such a connector housing.

### Background Art

For example, a wire harness may be intended to be arranged at a location which may be subject to liquid splashing such as water, such as wiring under a bottom of an automobile. Conventionally, many of wire harnesses to be arranged at such a location have a structure for suppressing liquid entering the inside of a connector housing, the connector housing being provided at an end of the wire harness. In such a connector housing, an electric wire section of a terminal-equipped electric wire with a connector terminal accommodated therein may extend to the outside at a rear side of the connector housing, wherein this rear side tends to be weakened with regard to liquid entering the inside. Here, the connector housing often has a structure on the rear side on which the electric wire section extends out, the structure being configured for suppressing liquid entering the rear side.

As an example for such a structure, a structure is known which tightly seals a gap between an outer circumferential surface of the electric wire section and an inner circumferential surface of a tubular housing main body of the connector housing with a seal element in a rear side opening of the housing main body, the seal element containing a resin (e.g. see Patent Document 1). In this structure, the seal element is fitted into the rear side opening of the housing main body, and the rear side opening is closed by means of a rear holder in order to prevent this seal element from dropping out. Further, the seal element comes into tight contact with an inner circumferential surface of the housing main body, and has a sealing through hole which comes into tight contact with the outer circumferential surface of the electric wire section on an inner circumferential side, wherein the rear holder has a passage hole which allows the electric wire section to pass therethrough to the outside.

In this case, in view of the operability for assembling the wire harness, it is desirable that a resistance force is reduced which is present when passing the electric wire section of the terminal-equipped electric wire through the sealing through hole of the seal element and/or through the passage hole of the rear holder. With regard to the sealing through hole, a certain resistance is unavoidable since it is required to be in tight contact with the outer circumferential surface of the electric wire section. On the other hand, with regard to the passage hole of the rear holder, a larger opening area of the passage hole than a radial cross section area of the electric wire section results in reduction of the resistance force, which enables the operability for assembling the wire harness to be improved to a corresponding extent.

### CITATION LIST

### Patent Literature

Patent Document 1: JP 2019-200907 A

### SUMMARY OF THE INVENTION

Here, depending on an arrangement geometry of the wire harness, the electric wire section extending out of the passage hole of the rear holder may be bent in a direction which follows the arrangement geometry. In the case of a larger passage hole of the rear holder as described above, the electric wire section is tilted in the bending direction due to a clearance between the inner circumferential surface of the passage hole and the outer circumferential surface of the electric wire section. As a result, the electric wire section may be drawn to one side also in the sealing through hole due to tilting the electric wire section within the passage hole, wherein an inner circumference of the sealing through hole is compressed on this one side to increase the tight contact while a tight contact on the opposite side may be reduced. Such an inhomogeneous tight contact for the sealing through hole may result in reduction of a sealing performance of the seal element which is not desirable.

Therefore, the present invention is focused on problems as above described, and an objective of the present invention is to provide a connector housing which can simultaneously achieve an improved operability for assembling a wire harness as well as a suppressed reduction of a sealing performance in the case of bending an electric wire section of a terminal-equipped electric wire. Another objective of the present invention is to provide a wire harness with such a connector housing.

In order to achieve the above-described objective, a connector housing includes a housing main body having a tubular shape and configured to accommodate a connector terminal of a terminal-equipped electric wire in order to connect the connector terminal to a partner connector terminal in a connected side opening of the housing main body for a partner connector; a seal element which is a sealing compound having a resin and configured to tightly seal a gap between an outer circumferential surface of an electric wire section of the terminal-equipped electric wire and an inner circumferential surface of the housing main body, the electric wire section extending to an outside from a rear side opening which is opposite to the connected side opening of the housing main body, wherein the seal element is configured to be fitted into the rear side opening so as to come into tight contact with the inner circumferential surface of the housing main body, and has a sealing through hole which is configured to come into tight contact with the outer circumferential surface of the electric wire section on an inner circumferential side while inserting the electric wire section through the sealing through hole; and a rear holder which is a lid element configured to be attached to the housing main body so as to close the rear side opening and has a passage hole and a plurality of protrusions, the passage hole allowing the electric wire section to pass therethrough and having a larger opening area than a radial cross section area of the electric wire section, wherein the plurality of protrusions protrudes from an inner circumferential surface of the passage hole with a protrusion length in such a way that at least one of vertices of the plurality of protrusions is positioned in each of three regions of the passage hole which are obtained by dividing the passage hole equally around its center in a circumferential direction in a plan view on the passage hole, the protrusion length being adapted to an inner circumference position of the sealing through hole.

Further, in order to achieve the above-described objective, a wire harness includes a terminal-equipped electric wire; and the connector housing as described above which accommodates the connector terminal of the terminal-equipped electric wire.

In the connector housing as described above, the passage hole of the rear holder for passing the electric wire section of the terminal-equipped electric wire therethrough has a larger opening area than the radial cross section area of the electric wire section, whereby the resistance force is reduced which is present when passing the electric wire section through this passage hole. With this reduction of the resistance force, it is possible to improve the operability for assembling a wire harness having this first connector housing. Furthermore, the plurality of protrusions is provided on the inner circumferential surface of the passage hole in the rear holder, the protrusions protruding therefrom with the protrusion length which is adapted to the inner circumference position of the sealing through hole. Additionally, these protrusions are provided in such a way that at least one of the vertices of the plurality of protrusions is positioned in each of the three regions of the passage hole which are obtained by dividing the passage hole equally around its center in the circumferential direction in the plan view on the passage hole. Since the electric wire section extending through the passage hole is supported substantially uniformly in three directions by these protrusions, it is possible to limit the movement of the electric wire section in the passage hole and thus suppress its tilting, for the electric wire section being bent in any direction. With this suppression of tilting in the rear holder, it is also possible to suppress the electric wire section tilting in the sealing through hole of the seal element which may cause an inhomogeneous contact with the electric wire section. In this manner, the connector housing as described above enables the operability for assembling the wire harness to be improved while simultaneously suppressing the reduction of the sealing performance when the electric wire section of the terminal-equipped electric wire is bent.

Moreover, the wire harness as described above includes the first connector housing or second connector housing as described above, which enables the operability for assembling the wire harness to be improved while simultaneously suppressing the reduction of the sealing performance when the electric wire section of the terminal-equipped electric wire is bent.

### BRIEF DESCRIPTION OF THE DRAWINGS

FIG. 1 is a perspective view of a wire harness according to a first embodiment;

FIG. 2 is a perspective view of a connector housing of the wire harness according to FIG. 1 with a terminal-equipped electric wire removed;

FIG. 3 shows a partial sectional view of the wire harness according to FIG. 1 along the line V11-V11 in FIG. 1;

FIG. 4 is an enlarged perspective view of a rear holder according to FIGS. 1 to 3;

FIG. 5 shows a plan view geometry of the rear holder according to FIG. 4;

FIG. 6 is a plan view a rear holder with protrusions formed on an inner circumferential surface of a passage hole according to a second embodiment; and

FIG. 7 schematically shows the protrusions according to FIG. 6 in a sectional view along an axial direction of the passage hole having the protrusions therein, with an electric wire section extending through the passage hole.

### DETAILED DESCRIPTION OF THE PREFERRED EMBODIMENTS

Hereinafter, embodiments for a connector housing and a wire harness will be described. First, a first embodiment will be described.

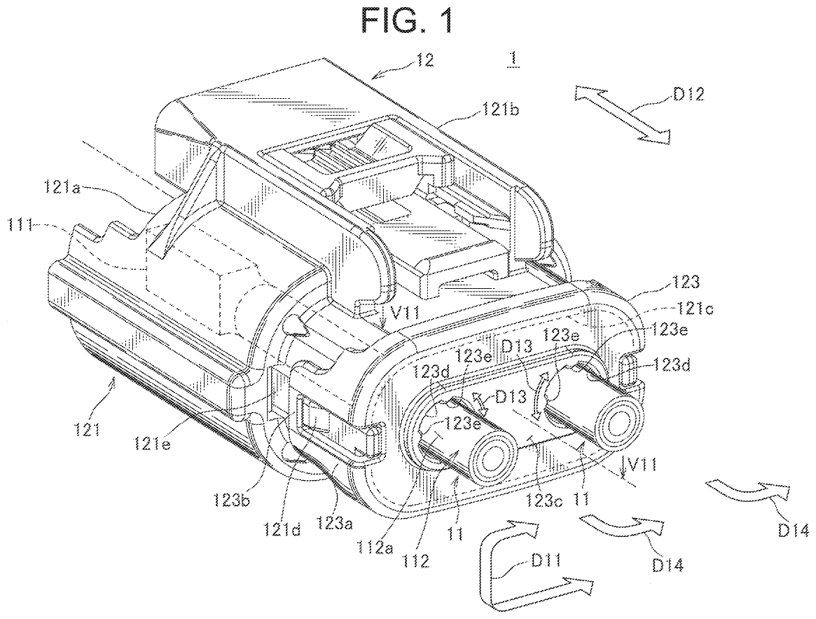

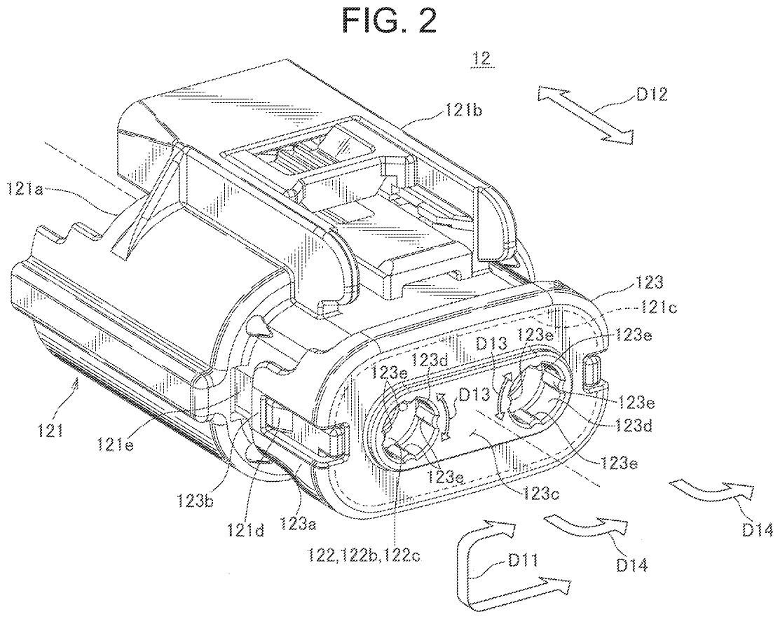

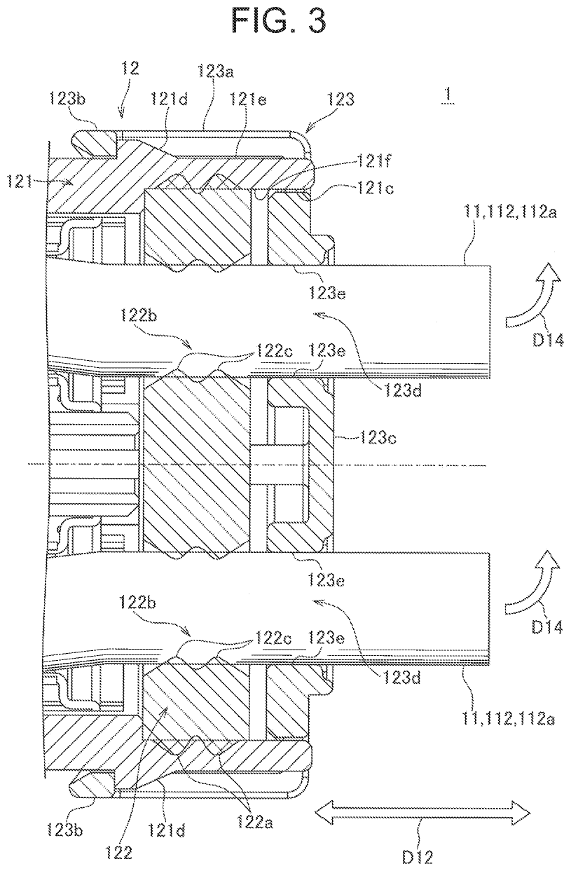

FIG. 1 shows a perspective view of a wire harness according to a first embodiment. FIG. 2 shows perspective view of a connector housing of the wire harness according to FIG. 1 with a terminal-equipped electric wire removed. FIG. 3 shows a partial sectional view of the wire harness according to FIG. 1 along the line V11-V11 in FIG. 1.

A wire harness 1 as shown in these FIGS. 1 to 3 is provided for arrangement at a location which may be subject to liquid splashing such as water, e.g. wiring under a bottom of an automobile. The wire harness 1 according to the present embodiment is configured as a two-pole wire harness, and includes two terminal-equipped electric wires 11 and a connector housing 12.

Each of the terminal-equipped electric wires 11 includes a female connector terminal 111 connected to an end of an electric wire section 112, the connector terminal 111 having a receptacle shape, wherein the electric wire section 112 is formed by a coated electric wire.

The connector housing 12 is an element for accommodating the two connector terminals 111 of the two terminal-equipped electric wires 11, wherein the connector housing 12 includes a housing main body 121, a seal element 122 and a rear holder 123.

The housing main body 121 is formed from a hard resin in a flat rectangular tube shape, and capable of accommodating the two connector terminals 111 so as to connect them to partner connector terminals in a connected side opening 121a for a partner connector. The housing main body 121 includes a locking section 121b on its outer circumferential surface closer to the connected side opening 121a, wherein the locking section 121b is configured to be engaged with a locked section of the partner connector when being fitted to the partner connector. The housing main body 121 further includes engaged sections 121d closer to a rear side opening 121c which is opposite to the connected side opening 121a, wherein the engaged sections 121d are configured to be engaged with engaging sections 123b of the rear holder 123 which will be described below. The engaged sections 121d are claw-shaped sections which protrude from a circumferential wall 121e of the housing main body 121, wherein one engaged section 121d is provided on each of a pair of opposed lateral faces of the circumferential wall 121e closer to the rear side opening 121c, totally two engaged sections 121d are provided, wherein the opposed lateral faces correspond to short sides of a substantially rectangular plan view shape of the rear side opening 121c.

The seal element 122 is a sealing compound which is configured to tightly seal a gap between outer circumferential surfaces 112a of the electric wire sections 112 of the two terminal-equipped electric wires 11 and an inner circumferential surface 121f the circumferential wall 121e of the housing main body 121, the electric wire sections 112 extending to the outside from the rear side opening 121c of the housing main body 121. The seal element 122 is an element having a substantially rectangular plate shape which is formed with a soft resin, such as a rubber. On an outer circumferential side of the seal element 122, a plurality of outer circumferential lips 122a is provided in an axial direction D12 so as to be in tight contact with the inner circumferential surface 121f of the housing main body 121, the outer circumferential lips 122a extending along a circumferential direction D11 of the seal element 122. Further, the seal element 122 has two sealing through holes 122b arranged therein which come into tight contact with the outer circumferential surfaces 112a of the electric wire sections 112 on inner circumferential sides while each inserting the electric wire section 112 through the sealing through hole 122b. On inner circumferential sides of the sealing through holes 122b, a plurality of inner circumferential lips 122c is provided in an axial direction D12 so as to be in tight contact with the outer circumferential surfaces 112a of the electric wire sections 112, the inner circumferential lips 122c extending along a circumferential direction D13 of the sealing through holes 122b.

The rear holder 123 is configured as a rectangular tubular cap with a lid containing the same hard resin as the housing main body 121, and is a lid element configured to be placed over the rear side opening 121c so as to close it and be attached to the housing main body 121. At a pair of opposed lateral walls of a circumferential wall 123a of the rear holder 123, engaging sections 123b are provided which are engaged with the engaged sections 121d of the housing main body 121, the engaging sections 123b being configured to cross over the claw-shaped engaged sections 121d in order to be engaged therewith, wherein the pair of opposed lateral walls of the rear holder 123 corresponds to short sides of a plan view rectangular shape of the circumferential wall 123a. One of the engaging sections 123b is provided at each of the pair of opposed lateral walls so as to be associated with the pair of engaged sections 121d in a one-to-one manner, totally two engaging sections 123b are provided.

Further, two passage holes 123d are provided in the rear holder 123 in a lid wall 123c forming a rectangular shape with a lid, each of the passage holes 123d allowing one of two electric wire sections 112 to pass therethrough, wherein the passage holes 123d extend coaxially with the two sealing through holes 122b of the seal element 122 inside the lid wall 123c. These passage holes 123d have a larger opening area than a radial cross section area of the electric wire sections 112. Furthermore, four protrusions 123e are provided on an inner circumferential surface of each of the passage holes 123d as follows:

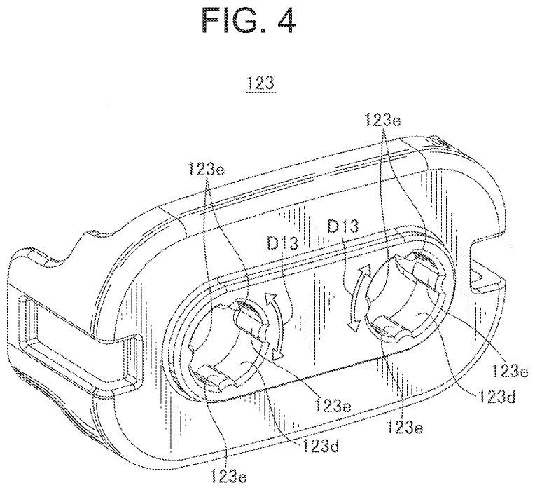

FIG. 4 shows an enlarged perspective view of the rear holder according to FIGS. 1 to 3, and FIG. 5 shows a plan view geometry of the rear holder according to FIG. 4.

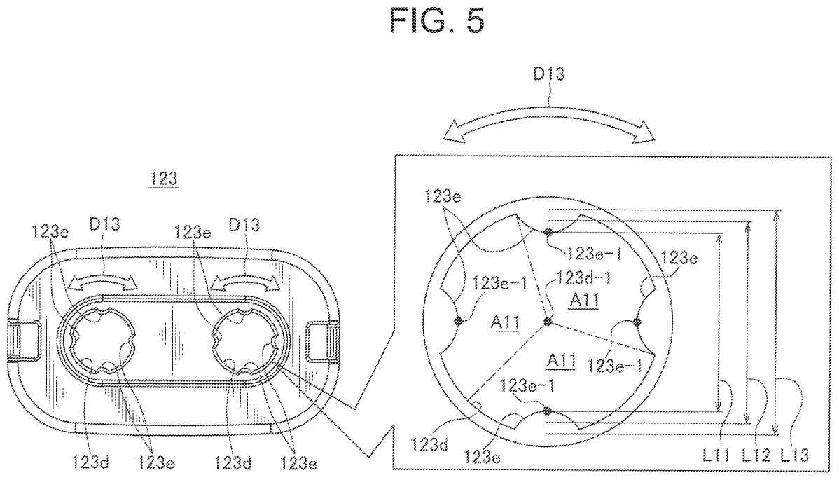

As shown in these FIGS. 4 and 5, the four protrusions 123e are arranged equidistantly in a circumferential direction D13 of the passage holes 123d on the circumferential surfaces of the two passage holes 123d in the rear holder 123. Here, the four protrusions 123e are arranged in such a way that at least one of vertices 123e-1 of the protrusions 123e is positioned in each of three regions All of each of the passage holes 123d which are obtained by dividing each of the passage holes 123d in a plan view on the passage holes 123d, as shown in an enlarged view of FIG. 5. The three regions A11 with the vertices 123e-1 of the protrusions 123e therein are formed by dividing each of the passage holes 123d equally around a center 123d-1 of the passage hole 123d at an interval of 120° in the circumferential direction D13. According to the present embodiment, the four protrusions 123e are arranged in such a way that two vertices 123e-1 are positioned in one of the three regions A11 and one vertex 123e-1 is positioned in each of the two remaining regions A11.

Furthermore, a vertex distance L11 for the protrusions 123e, an electric wire diameter L12 of the electric wire sections 112, and a hole diameter L13 of the passage holes 123d are in a dimension relation as described below, wherein the vertex distance L11 is measured between the vertices of protrusions 123e which are opposed to each other with respect to the center 123d-1:

Vertex distance L11<electric wire diameter L12<hole diameter L13.

First, the dimension relation of electric wire diameter L12 of the electric wire sections 112<hole diameter L13 of the passage holes 123d means that the opening area of a passage hole 123d is larger than the radial cross section area of an electric wire section 112.

In this case, when the electric wire sections 112 are inserted through the sealing through holes 122b in the seal element 122 as shown in FIG. 3, the inner circumferential lips 122c are compressed and crushed so that the electric wire diameter L12 of the electric wire sections 112 substantially coincides with an inner diameter of the sealing through holes 122b. This means that a position for a vertex 123e-1 of each of the protrusions 123e overhangs from the inner circumferential surface of the passage hole 123d with a protrusion length according to the dimension relation of vertex distance L11 of the protrusions 123e<electric wire diameter L12 of the electric wire sections 112, the protrusion length being adapted to an inner circumference position of the sealing through hole 122b.

Further, due to fulfilling the dimension relation as described above, the electric wire sections 112 inserted through the passage holes 123d are supported by the vertices 123e-1 of the four protrusions 123e, wherein the outer circumferential surfaces 112a of the electric wire sections 112 are in a non-contact state with the inner circumferential surfaces of the passage holes 123d.

According to the wire harness 1 and the connector housing 12 of the first embodiment as described above, the passage holes 123d of the rear holder 123 have a larger opening area than the radial cross section area of the electric wire sections 112. Due to such a configuration of the passage holes 123d, a resistance force is reduced which is present when inserting the electric wire sections 112 through the passage holes 123d. With this reduction of the resistance force, it is possible to improve the operability for assembling the wire harness 1 having this connector housing 12.

According to the present embodiment, the electric wire section 112 which extends out of the passage hole 123d in the rear holder 123 is bent in a bending direction D14 as shown by an arrow in FIGS. 1 to 3 by way of example, depending on an arrangement geometry of the wire harness 1. In order to suppress the electric wire section 112 being tilted within the passage hole 123d of the rear holder 123 due to bending as described above, the four protrusions 123e are provided on the inner circumferential surface of the passage hole 123d. As described above, the four protrusions 123e are provided on the inner circumferential surface of the passage hole 123d so as to protrude therefrom with the protrusion length which is adapted to the inner circumference position of the sealing through hole 122b. Further, the four protrusions 123e are arranged in such a way that at least one of vertices 123e-1 of the plurality of protrusions 123e is positioned in each of three regions All of each of the passage holes 123d which are obtained by dividing each of the passage holes 123d equally around its center 123d-1 in the circumferential direction in the plan view on the passage holes 123d. The electric wire section 112 inserted through the passage hole 123d is supported substantially uniformly in three directions by these four protrusions 123e. Due to this uniformly supporting, it is possible to limit the movement of the electric wire section 112 in the passage hole 123d and thus suppress its tilting, for the electric wire section 112 being bent in any direction, including the bending direction D14 as shown in FIGS. 1 to 3 by way of example. With this suppression of tilting in the rear holder 123, it is also possible to suppress the electric wire section 112 tilting in the sealing through hole 122b of the seal element 122 which may cause an inhomogeneous contact with the electric wire section 112. In this manner, the present embodiment enables the operability for assembling the wire harness 1 to be improved while simultaneously suppressing the reduction of the sealing performance when the electric wire section 112 of the terminal-equipped electric wire 11 is bent.

According to the present embodiment, each of the four protrusions 123e at the rear holder 123 has a rib shape which extends from an extending-out side of the electric wire section 112 to a side facing the seal element 122 in the axial direction D12 of the passage hole 123d. According to this configuration, the four protrusions 123e have a rib shape which extends from the extending-out side of the electric wire section 112 on which the electric wire section 112 can be tilted most easily when being bent, wherein the rib shape extends to the side facing the seal element 122 where the sealing performance tends to be affected. Due to each of the protrusions 123e being configured in such a rib shape, it is possible to effectively suppress reduction in the sealing performance when the electric wire sections 112 of the terminal-equipped electric wires 11 are bent.

Furthermore, according to the present embodiment, each of the four protrusions 123e of the rear holder 123 has an orthogonal cross section extending orthogonally to the axial direction D12 of the passage hole 123d, the orthogonal cross section having a tapered shape which is tapered in a direction away from the inner circumferential surface of the passage hole 123d. More specifically, each of the protrusions 123e has a tapered rib shape with a rounded tip, i.e., a substantially semi-cylindrical shape, as shown in the perspective views of FIGS. 2 and 4. With this configuration, it is possible to reduce a contact area between the four protrusions 123e and the electric wire section 112, which enables the resistance force to be further reduced which is present when inserting the electric wire section 112 through the passage hole 123d.

The description of the first embodiment shall be ended here, and hereinafter, a second embodiment will be described. The second embodiment shows an exemplar variation of protrusions according to the first embodiment. On the other hand, the remaining features of a connector housing and/or wire harness according to the second embodiment are identical with those of the connector housing 12 and/or wire harness 1 according to the first embodiment. The following description of the second embodiment is focused on differences from the first embodiment, wherein description and/or illustration will be omitted for identical features of both embodiments.

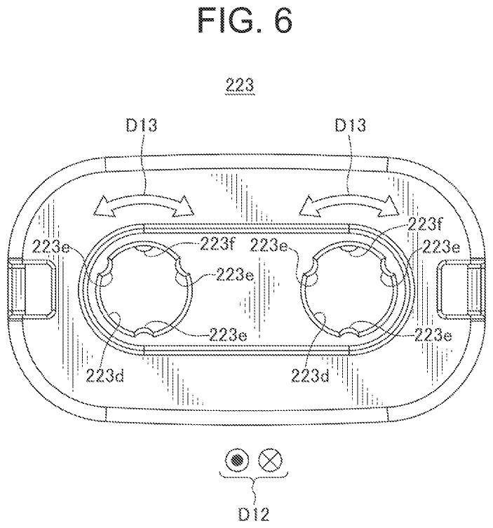

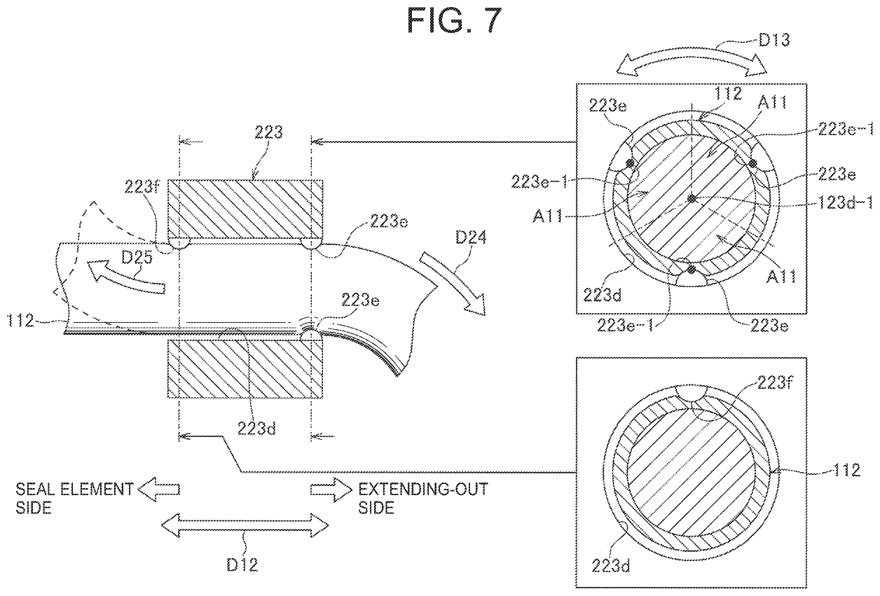

FIG. 6 is a plan view a rear holder with protrusions formed on an inner circumferential surface of a passage hole according to the second embodiment. FIG. 7 schematically shows the protrusions according to FIG. 6 in a sectional view along an axial direction of the passage hole having the protrusions therein, with an electric wire section extending through the passage hole. It is to be noted that in FIGS. 6 and 7, the same elements as those in the first embodiment according to FIGS. 1 to 5 are designated by the same reference signs as those in FIGS. 1 to 5, wherein repeating the description of these same elements will be omitted in the following description. It is to be further noted that in the sectional view of FIG. 7, the left side and the right side correspond to an extending-out side of the electric wire sections 112 and a side facing the seal element 122, respectively.

According to the second embodiment, on an inner circumferential surface of each of passage holes 223d in a rear holder 223, three protrusions 223e are arranged so as to be localized to the extending-out side of the electric wire section with respect to an axial direction D12 of the passage hole 223d. The three protrusions 223e are arranged in such a way that one of vertices 223e-1 of the plurality of protrusions 223e is positioned in each of three regions All of each of the passage holes 223d which are obtained by dividing each of the passage holes 223d equally around its center 123d-1 in the circumferential direction D13 in the plan view on the passage holes 223d. More specifically, the three protrusions 223e are arranged equidistantly at an interval of 120° around the center 123d-1 so that a vertex 223e-1 of each of the protrusions 223e is arranged in the middle of a region All in the circumferential direction D13.

Further, each of the protrusions 223e protrudes from the inner circumferential surface of the passage hole 223d with a protrusion length so that the vertices 223e-1 intrude slightly into a resin coating on the electric wire section 112 which extends through the passage hole 223d, the protrusion length being adapted to an inner circumference position of the sealing through hole 122b. Furthermore, each of the protrusions 223e has an orthogonal cross section extending orthogonally to the axial direction D12 which is tapered with a rounded tip. However, the protrusions 223e according to the present embodiment are not semi-cylindrical like in the first embodiment, but dome-shaped.

According to the present embodiment, one seal side protrusion 223f is additionally provided on the inner circumferential surface of the passage hole 223d so as to be localized on the side facing the seal element 122 with respect to the axial direction D12, the seal side protrusion extending from the inner circumferential surface of the passage hole 223d with a protrusion length, the protrusion length being adapted to the inner circumference position of the sealing through hole 122b. This seal side protrusion 223f has a dome shape, similarly to the three protrusions 223e on the extending-out side of the electric wire section 112. Moreover, the seal side protrusion 223f is disposed in such a way that it is not overlapped with the three protrusions 223e in the plan view on the passage hole 223d.

According to the present embodiment, the electric wire section 112 which extends out of the passage hole 223d is bent in the bending direction D24 as shown by an arrow in FIG. 7, wherein the arrow is curved downwards. In this case, tilting the electric wire section 112 within the passage hole 223d in this bending direction D24 is suppressed by the three protrusions 223e on the extending-out side of the electric wire section 112. At this time, on the opposite side of the passage hole 223d facing the seal element 122, a counterforce of the bending causes a force to act which causes the electric wire section 112 to be tilted in a movement direction D25, the movement direction D25 being oriented opposite to the bending direction D24 and upward. The seal side protrusion 223f serves for suppressing the movement caused by the counterforce of the bending, wherein one seal side protrusion 223f should be arranged on the inner circumferential surface of the passage hole 223d in a position opposite to the bending direction D24.

Of course, similarly to the first embodiment, the second embodiment as described above enables the operability for assembling the wire harness to be improved while simultaneously suppressing the reduction of the sealing performance when the electric wire section 112 of the terminal-equipped electric wire 11 is bent.

According to the present embodiment, the three protrusions 223e of the rear holder 223 are arranged so as to be localized to the extending-out side of the electric wire section 112 with respect to the axial direction D12 of the passage hole 223d. According to this configuration, the three protrusions 223e for suppression of tilting are provided in the passage hole 223d of the rear holder 223 on the extending-out side of the electric wire section 112 where the electric wire section 112 can be tilted most easily when being bent. Due to the three protrusions 223e being arranged in such a position, it is possible to effectively suppress reduction in the sealing performance when the electric wire sections 112 of the terminal-equipped electric wires 11 are bent. According to this configuration, the three protrusions 223e are localized to the extending-out side of the electric wire section 112, whereby a contact area between the protrusions 223e and the electric wire section 112. This reduction of the contact area enables the resistance force to be further reduced which is present when inserting the electric wire section 112 through the passage hole 223d.

According to the present embodiment, one seal side protrusion 223f is additionally provided on the inner circumferential surface of the passage hole 223d so as to be localized on the side facing the seal element 122 with respect to the axial direction D12 of the passage hole 223d, the seal side protrusion 223f extending from the inner circumferential surface of the passage hole 223d with a protrusion length, the protrusion length being adapted to the inner circumference position of the sealing through hole 122b. According to this configuration, tilting the electric wire section 112 is suppressed on the side of the passage hole 223d of the rear holder 223 facing the seal element 122 as well by the at least one seal side protrusion 223f, which enables reduction of the sealing performance to be suppressed more effectively. Similarly to the three protrusions 223e, the seal side protrusion 223f is localized and a contact area with the electric wire section 112 is thus reduced, which enables the resistance force to be reduced which is present when inserting the electric wire section 112 through the passage hole 223d.

According to the present embodiment, the seal side protrusion 223f is disposed in such a way that it is not overlapped with the three protrusions 223e on the extending-out side in the plan view on the passage hole 223d. Since the seal side protrusion 223f is not overlapped with the three protrusions 223e in the plan view, this configuration enables e.g. demolding through the passage hole 223d in the axial direction D12 to be facilitated, for example in a process of molding the rear holder 223 by introducing a molten resin into the mold.

It is to be noted that the first and second embodiments as described above merely show representative embodiments for the connector housing and wire harness, wherein the connector housing and wire harness are not limited thereto and may be implemented in various modifications.

For example, the first and second embodiments as described above show the wire harness 1 as an example for the wire harness, the wire harness 1 being provided for arrangement at a location which may be subject to liquid splashing such as water, e.g. wiring under a bottom of an automobile. However, the wire harness is not limited thereto, but may be configured to be arranged within a vehicle cabin of an automobile, wherein the wire harness may be arranged in any specific manner.

Furthermore, the first and second embodiments as described above show the two-pole connector housing 12 and wire harness 1 as examples for the connector housing and wire harness. However, the number of poles for the connector housing and wire harness is not limited to two, but they may have a single pole, or more than three poles. Further, in the case of a multi-pole connector housing and/or wire harness, arrangement of the terminal-equipped electric wire is not limited to a horizontal arrangement as shown in the first and second embodiments, but may be arranged vertically, or in multiple rows such as two or three rows.

Moreover, the first and second embodiments as described above show the circular passage holes 123d, 223d as an example for the passage hole of the rear holder. However, the passage hole of the rear holder is not limited thereto, but may have any specific shape, such as an elongate hole and/or a polygonal hole, as far as the passage opening has a larger opening area than the radial cross section area of the electric wire section of the terminal-equipped electric wire and allows the electric wire section to pass through the passage hole.

The first and second embodiments as described above further show four/three protrusions 123e, 223e as examples for the plurality of protrusions of the rear holder. However, the number of the protrusions of the rear holder is not limited to four or three. As long as at least one of vertices of the protrusions is positioned in each of three regions of the passage hole which are obtained by dividing the passage hole equally, five or more protrusions may be provided.

Furthermore, as examples for the protrusions, the first and second embodiments as described above show the protrusions 123e, 223e which extend in a rib shape from the extending-out side of the electric wire section 112 to the side facing the seal element 122 in the passage hole 123d, 223d or are localized to the extending-out side of the electric wire section 112. However, the protrusions are not limited thereto, but may be configured to be arranged locally in the middle of the passage hole with respect to the axial direction, for example. However, as described above, the protrusions 123e, 223e which extend in a rib shape or are localized to the extending-out side of the electric wire section 112 enable reduction in the sealing performance to be effectively suppressed when the electric wire section 112 is bent.

Further, the second embodiment shows the rear holder 223 which includes three protrusions 223e on the extending-out side of the electric wire section 112 on the inner circumferential surface of the passage hole 223d, and one seal side protrusion 223f on the side of the passage hole 223d facing the seal element 122, as an example for the rear holder. However, also in the case of multiple protrusions on the extending-out side of the electric wire section, the rear holder may be configured without a seal side protrusion on the side facing the seal element. However, as described above, the existence of the seal side protrusion 223f may result in more effective suppression of the reduction in the sealing performance. Also in the case of the rear holder with the seal side protrusion, the number of seal side protrusions is not limited to one, but multiple seal side protrusions may be provided on the side facing the seal element.

As an example for the rear holder, the second embodiment further shows the rear holder 223 which is configured so that the seal side protrusion 223f is not overlapped with the three protrusions 223e on the extending-out side of the electric wire section 112 in the plan view. However, in embodiments with the seal side protrusion, the seal side protrusion may be overlapped with the protrusions on the extending-out side of the electric wire section. However, with the seal side protrusion 223f which is not overlapped with the protrusions 223e on the extending-out side of the electric wire section 112, it is possible to facilitate e.g. demolding through the passage hole in the axial direction in the case of molding the rear holder 223 with a resin, as described above.

Moreover, the first and second embodiments as described above show the rib-shaped protrusions 123e with a semi-cylindrical shape and the dome-shaped protrusions 223e which have a tapered shape in their orthogonal cross sections which extends orthogonally to the axial direction D12 of the passage hole 123d, 223d, as examples for the protrusions. However, the protrusions are not limited thereto, but may have any specific shape, such as a rectangular rib shape and/or a rectangular protrusion shape. However, as described above, with the protrusions 123e, 223e having a tapered shape in their cross sections orthogonal to the axial direction D12, it is possible to further reduce the resistance force which exists when inserting the electric wire section 112 through the passage hole 123d, 223d.

### REFERENCE SIGNS LIST

1 Wire harness
11 Terminal-equipped electric wires
12 Connector housing
111 Connecter terminals
112 Electric wire sections
112a Outer circumferential surfaces
121 Housing main body
121a Connected side opening
121b Locking section
121c Rear side opening
121d Engaged portions
121e, 123a Circumferential walls
121f Inner circumferential surface
122 Seal element
122a Outer circumferential lips
122b Sealing through holes
122c Inner circumferential lips
123, 223 Rear holder
123b Engaging portions
123d, 223d Passage holes
123e, 223e Protrusions
123e-1, 223e-1 Vertices
123c Lid wall
223f Seal side protrusions
A11 Regions
D11, D13 Circumferential direction
D12 Axial direction
D14, D24 Bending direction
D25 Movement direction

What is claimed is:

1. A connector housing comprising:
a housing main body having a tubular shape and configured to accommodate a connector terminal of a terminal-equipped electric wire in order to connect the connector terminal to a partner connector terminal in a connected side opening of the housing main body for a partner connector;
a seal element which is a sealing compound having a resin and configured to tightly seal a gap between an outer circumferential surface of an electric wire section of the terminal-equipped electric wire and an inner circumferential surface of the housing main body, the electric wire section extending to an outside from a rear side opening which is opposite to the connected side opening of the housing main body, wherein the seal element is configured to be fitted into the rear side opening so as to come into tight contact with the inner circumferential surface of the housing main body, and has a sealing through hole which is configured to come into tight contact with the outer circumferential surface of the electric wire section on an inner circumferential side while inserting the electric wire section through the sealing through hole; and
a rear holder which is a lid element configured to be attached to the housing main body so as to close the rear side opening and has a passage hole and a plurality of protrusions, the passage hole allowing the electric wire section to pass therethrough and having a larger opening area than a radial cross section area of the electric wire section, wherein the plurality of protrusions protrudes from an inner circumferential surface of the passage hole with a protrusion length in such a way that at least one of vertices of the plurality of protrusions is positioned in each of three regions of the passage hole which are obtained by dividing the passage hole equally around its center in a circumferential direction in a plan view on the passage hole, the protrusion length being adapted to an inner circumference position of the sealing through hole.

2. The connector housing according to claim 1,
wherein each of the plurality of protrusions of the rear holder has a rib shape which extends from an extending-out side of the electric wire section to a side facing the seal element in an axial direction of the passage hole.

3. The connector housing according to claim 1,
wherein the plurality of protrusions of the rear holder is localized to an extending-out side of the electric wire section with respect to an axial direction of the passage hole.

4. The connector housing according to claim 3, further comprising at least one seal side protrusion,
wherein the seal side protrusion is provided on the inner circumferential surface of the passage hole of the rear holder so as to be localized to the side facing the seal element with respect to the axial direction of the passage hole, the seal side protrusion extending from the inner circumferential surface of the passage hole with a protrusion length, the protrusion length being adapted to the inner circumference position of the sealing through hole.

5. The connector housing according to claim 4,
wherein the seal side protrusion is disposed in such a way that it is not overlapped with the plurality of protrusions in the plan view on the passage hole.

6. The connector housing according to claim 1,
wherein each of the plurality of protrusions of the rear holder has an orthogonal cross section extending orthogonally to an axial direction of the passage hole, the orthogonal cross section having a tapered shape which is tapered in a direction away from the inner circumferential surface of the passage hole.

7. The connector housing according to claim 2,
wherein each of the plurality of protrusions of the rear holder has an orthogonal cross section extending orthogonally to an axial direction of the passage hole, the orthogonal cross section having a tapered shape which is tapered in a direction away from the inner circumferential surface of the passage hole.

8. The connector housing according to claim 3,
wherein each of the plurality of protrusions of the rear holder has an orthogonal cross section extending orthogonally to an axial direction of the passage hole, the orthogonal cross section having a tapered shape which is tapered in a direction away from the inner circumferential surface of the passage hole.

9. The connector housing according to claim 4,
wherein each of the plurality of protrusions of the rear holder has an orthogonal cross section extending orthogonally to an axial direction of the passage hole, the orthogonal cross section having a tapered shape which is tapered in a direction away from the inner circumferential surface of the passage hole.

10. The connector housing according to claim 5,
wherein each of the plurality of protrusions of the rear holder has an orthogonal cross section extending orthogonally to an axial direction of the passage hole, the orthogonal cross section having a tapered shape which is tapered in a direction away from the inner circumferential surface of the passage hole.

11. A wire harness comprising:
a terminal-equipped electric wire; and
the connector housing according to claim 1 which accommodates the connector terminal of the terminal-equipped electric wire.
